(19) United States
(12) Patent Application Publication
(10) Pub. No.: US 2018/0298309 A1
(43) Pub. Date: Oct. 18, 2018

(54) LIQUID DETERGENTS OR CLEANING AGENTS CONTAINING ACYL HYDRAZONE AND REDUCING AGENTS

(71) Applicant: Henkel AG & Co. KGaA, Duesseldorf (DE)

(72) Inventors: Christian Kropf, Hilden (DE); Andre Haetzelt, Duesseldorf (DE)

(73) Assignee: Henkel AG & Co. KGaA, Duesseldorf (DE)

(21) Appl. No.: 16/010,726

(22) Filed: Jun. 18, 2018

Related U.S. Application Data
(63) Continuation of application No. PCT/EP2016/079986, filed on Dec. 7, 2016.

(30) Foreign Application Priority Data
Dec. 18, 2015 (DE) 10 2015 225 881.5

(51) Int. Cl. C11D 3/28; C11D 3/00; C11D 3/26; C11D 17/00

(52) U.S. Cl. CPC C11D 3/28; C11D 17/0013; C11D 3/26; C11D 3/0042

(57) ABSTRACT

Improving the cleaning power of liquid detergents and cleaning agents in relation to stains. This is substantially achieved by incorporating a combination of a specific acyl hydrazone and reducing agents.

### FIELD OF THE INVENTION

The present application relates to liquid washing or cleaning agents that contain a surfactant, a reducing agent and a particular acyl hydrazone, and to the use of a combination of an acyl hydrazone of this kind and reducing agents, for improving the dirt-removal performance of liquid washing or cleaning agents.

### BACKGROUND OF THE INVENTION

For incorporating liquid surfactant compositions, in particular washing or cleaning agents, either those ingredients that dissolve in the liquid phase of the agent or those that can be accordingly homogeneously suspended in an undissolved manner are available. For insoluble ingredients, a stable, homogeneous suspension is required for the function and aesthetics of the washing or cleaning agent. Sedimented solid particles may clump together and, when used, may lead to local excess concentrations of the ingredient and thus to uneven dosing per wash load. In addition, visible clumps, greasy deposits or residues of the solid ingredient on an e.g. transparent wall of the storage container are not esthetically pleasing.

Certain, optionally dyed, solid particles, which are visible to the naked human eye in suspension in a transparent or translucent, liquid phase as individualized particles and are incorporated, are often referred to as speckles. For this purpose, corresponding particles have an appropriate particle size and are esthetically attractive to the consumer. Microcapsules are also solid ingredients and include any type of capsule known to a person skilled in the art, but in particular core-shell capsules and matrix capsules. Matrix capsules are porous shaped bodies that have a structure similar to a sponge. Core-shell capsules are shaped bodies that have a core and a shell.

Sedimentation of suspended particles can be prevented by the use of liquid surfactant compositions having a yield point. A yield point can be produced by selecting specific surfactant combinations, usually in the presence of an electrolyte salt, by establishing a lamellar phase. It is also possible to use polymer thickeners for producing a yield point.

International patent application WO 2009/124855 A1 discloses metal complexes having acyl hydrazone ligands that have electron-withdrawing substituents in the proximity of the acyl group. International patent application WO 2012/08088 A1 relates to acyl hydrazones having cyclic ammonium groups as substituents in the proximity of the acyl group. International patent application WO 2013/104631 A1 discloses the use of certain acyl hydrazones for improving the dirt-removal performance of washing or cleaning agents with respect to stains from polysaccharide-containing food residues.

### BRIEF SUMMARY OF THE INVENTION

The object of the present invention is to provide liquid washing or cleaning agents that, even when they do not contain a peroxidic bleaching agent, have excellent washing or cleaning power with respect to stains that are conventionally removed, at least in portions, by using peroxygen-based bleach systems.

It has surprisingly been found that this object can be achieved by using a combination of reducing agents and acyl hydrazones.

The invention relates to the use of a combination of an acyl hydrazone of general formula I,

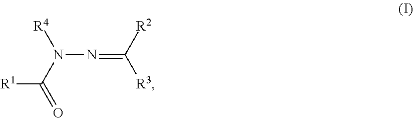

in which R¹ represents a CF₃ or a C₁₋₂₈ alkyl, C₂₋₂₈ alkenyl, C₂₋₂₂ alkinyl, C₃₋₁₂ cycloalkyl, C₃₋₁₂ cycloalkenyl, phenyl, naphthyl, C₇₋₉ aralkyl, C₃₋₂₀ heteroalkyl or C₃₋₁₂ cycloheteroalkyl group,
R² and R³ represent, independently of one another, hydrogen or an optionally substituted C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl or heteroaryl group, or R² and R³ represent, together with the carbon atom which connects them, an optionally substituted 5, 6, 7, 8 or 9-membered ring, which may optionally contain heteroatoms, and
R⁴ represents hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group or an optionally substituted phenyl or naphthyl or heteroaryl group,
with reducing agents, for improving the dirt-removal performance of liquid surfactant-containing washing or cleaning agents.

The invention further relates to liquid washing or cleaning agents, containing

1 wt. % to 70 wt. %, preferably 1.5 wt. % to 50 wt. %, and in particular 2 wt. % to 40 wt. %, of at least one surfactant,
at least one reducing agent, and
at least one acyl hydrazone of general formula I,

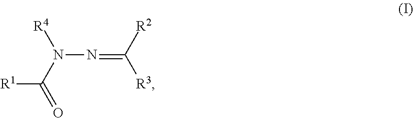

in which R¹ represents a CF₃ or a C₁₋₂₈ alkyl, C₂₋₂₈ alkenyl, C₂₋₂₂ alkinyl, C₃₋₁₂ cycloalkyl, C₃₋₁₂ cycloalkenyl, phenyl, naphthyl, C₇₋₉ aralkyl, C₃₋₂₀ heteroalkyl or C₃₋₁₂ cycloheteroalkyl group, R² and R³ represent, independently of one another, hydrogen or an optionally substituted C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl or heteroaryl group, or R² and R³ represent, together with the carbon atom which connects them, an optionally substituted 5, 6, 7, 8 or 9-membered ring, which may optionally contain heteroatoms, and
R⁴ represents hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group or an optionally substituted phenyl or naphthyl or heteroaryl group, and water.

The amounts in “wt. %” refer here and in the following to the total weight of the agent, unless specified otherwise.

The liquid agents may be washing agents for textiles, carpets or natural fibers, for example. In the context of the invention, the washing agents also include auxiliary washing agents, which are added to the actual washing agent when washing textiles by hand or using a machine in order to achieve an additional effect that is not, or not adequately, provided by the actual washing agent. Furthermore, in the context of the invention, washing agents also include pre-treatment and post-treatment washing agents, i.e. agents with which the piece of laundry comes into contact before or after it is actually washed, for example in order to loosen stubborn dirt or to make the laundry softer to touch and more comfortable to wear.

“Liquid” means that the washing or cleaning agent is in liquid form and is in particular flowable at room temperature, i.e. approximately 20° C., and can thus be poured out of a container, for example.

In the liquid agents of the invention or within the scope of the use according to the invention, the reducing agent and/or acyl hydrazone can be present in a dissolved or suspended form. In the embodiment mentioned last, both or at least one of them can be present in the form of powder or, if desired, granules containing conventional inert carrier materials, which powder or granules can also be encased in a manner that is in principle known.

Preferred structures for the acyl hydrazones include those of general formula (II),

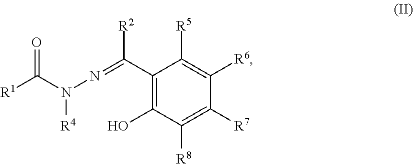

in which R¹ represents a C₁₋₄ alkyl group that has a substituent selected from

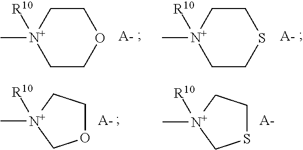

in which R¹⁰ represents hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group, and A⁻ represents the anion of an organic or inorganic acid,
R² and R⁴ have the meaning specified for formula (I), and
R⁵, R⁶, R⁷ and R⁸ represent, independently of one another, R¹, hydrogen, halogen, a hydroxy, amino, optionally substituted N-mono- or di-C₁₋₄ alkyl or C₂₋₄ hydroxyalkyl amino, N-phenyl or N-naphthyl amino, C₁₋₂₈ alkyl, C₁₋₂₈ alkoxy, phenoxy, C₂₋₂₈ alkenyl, C₂₋₂₂ alkinyl,
C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, phenyl or naphthyl group, the substituents being selected from C₁₋₄ alkyl, C₁₋₄ alkoxy, hydroxy, sulfo, sulfato, halogen, cyano, nitro, carboxy, phenyl, phenoxy, naphthoxy, amino, N-mono- or di-C₁₋₄ alkyl or C₂₋₄ hydroxyalkyl amino, N-phenyl or N-naphthyl amino groups, or
R⁵ and R⁶ or R⁶ and R⁷ or R⁷ and R⁸ are interconnected so as to form 1, 2 or 3 carbocyclic or O, NR¹⁰ or S heterocyclic, optionally aromatic and/or optionally C₁₋₆ alkyl-substituted rings.

The anion A⁻ is preferably a carboxylate, such as lactate, citrate, tartrate or succinate, perchlorate, tetrafluoroborate, hexafluorophosphate, alkylsulfonate, alkylsulfate, hydrogen sulfate, sulfate, dihydrogen phosphate, hydrogen phosphate, phosphate, isocyanate, thiocyanate, nitrate, fluoride, chloride, bromide, hydrogen carbonate or a carbonate, it being possible for the charge balance to be achieved in polyvalent anions by the presence of additional cations, such as sodium or ammonium ions.

The acyl hydrazone of formula (III) is particularly preferred,

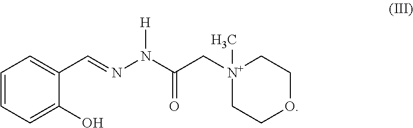 [SMILES: C[N+]1(CC(=O)N/N=C/c2ccccc2O)CCOCC1]

Agents according to the invention preferably contain 0.001 wt. % to 5 wt. %, in particular 0.05 wt. % to 2 wt. %, of acyl hydrazone.

The combination used according to the invention or an agent according to the invention contains reducing agents. A reducing agent is a substance which releases electrons, is thus able to reduce other substances, and is self-oxidized in the process. As a result of a reducing agent being present, the oxidation of other washing agent components and the reduction in performance associated therewith is prevented, or at least reduced, when the agent is being stored. However, the improvement in the dirt-removal performance of liquid agents achieved by means of the combination according to the invention is also observed in freshly prepared agents containing acyl hydrazone and reducing agents. Preferred reducing agents are selected from hydroxyl amine, which can be used as such or in the form of an acid addition compound, for example as hydrochloride, ascorbic acid, ascorbic acid alkali salts, isoascorbic acid, isoascorbic acid alkali salts, alkali sulfites, alkali hydrogen sulfites, aldehydes, such as hydroxy propandial, and mixtures of two or more of these reducing agents. In the combination used according to the invention, the weight ratio of acyl hydrazone to reducing agent is preferably in the range of from 5:1 to 1:5,000, in particular from 4:1 to 1:40. Agents according to the invention preferably contain 0.1 wt. % to 5 wt. %, in particular 0.5 wt. % to 2 wt. %, of reducing agents.

### DETAILED DESCRIPTION OF THE INVENTION

The use according to the invention and the use of an agent according to the invention improves the removal of bleachable stains, the use according to the invention and the use of an agent according to the invention being remarkable in particular owing to bleaching agents not being present. The removal of enzyme-sensitive stains is likewise improved; the presence of the combination of acyl hydrazone and reducing agents enhances the performance of enzymes, if enzymes are present.

Bleachable stains should be understood to be stains which are colored and are removed to a greater degree, or at least have a lighter shade, after being washed in the presence of a peroxidic bleaching agent, such as sodium percarbonate, and optionally a bleach activator, such as N,N,N′,N′-tetraacetylethylenediamine, by comparison with after having been washed without the peroxidic bleaching agent and optionally the bleach activator. The bleachable stains usually contain polymerizable substances, in particular dyes, the dyes preferably being polyphenolic dyes, in particular flavonoids, more particularly anthocyanidins or anthocyanins or oligomers of said compounds. In addition to removing green, yellow, red or blue stains, it is also possible to remove stains of intermediate colors, in particular violet, lilac, brown, crimson or pink, and stains which have a green, yellow, red, violet, lilac, brown, crimson, pink or blue tone, but which do not themselves substantially consist entirely of the relevant color. The colors mentioned may each be light or dark, in particular. The stains are preferably stains, in particular spots of grass, fruit or vegetables, in particular also stains from food products, such as condiments, sauces, chutneys, curry, purees and marmalades, or drinks, such as coffee, tea, wine and juice, which contain corresponding green, yellow, red, violet, lilac, brown, crimson, pink and/or blue dyes.

Enzyme-sensitive stains should be understood to be stains which are removed to a greater degree, or, when colored, have a lighter shade, after being washed in the presence of enzymes by comparison with after having been washed without the enzyme. These are preferably protein-containing, polysaccharide-containing and/or fat-containing stains, such as from egg, blood, starch, mannan, grass or dressings.

An agent according to the invention and preferably also an agent that is used within the scope of the use according to the invention contains an overall amount of from 1 to 70 wt. % of at least one surfactant. It is preferable according to the invention for the agent to contain an overall amount of from 1.5 wt. % to 50 wt. %, in particular 2 wt. % to 40 wt. %, of surfactant.

The liquid agent preferably contains at least one anionic surfactant, in particular selected from the group comprising C₈₋₁₈alkylbenzene sulfonates, olefin sulfonates, C₁₂₋₁₈ alkane sulfonates, ester sulfonates, alk(en)yl sulfates, fatty alcohol ether sulfates and mixtures thereof.

It is preferable for the agent to contain at least one anionic surfactant of formula (T1)

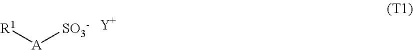

where
R¹ represents a linear or branched, substituted or unsubstituted functional group, selected from alkyl, aryl or alkyl aryl functional groups and
the group -A- represents a direct chemical bond or a functional group —(OZ)ₙ—O—,
where Z represents an alkylene group having 2 to 4 C atoms, in particular an ethylene and/or propylene group, and n represents an integer from 1 to 50, preferably from 1 to 20, and in particular from 2 to 10, more particularly preferably 2, 3, 4, 5, 6, 7 or 8, and
Y⁺ represents a monovalent cation or the n-th part of an n-valent cation.

R¹ preferably represents a linear, unsubstituted alkyl functional group, particularly preferably a fatty alcohol functional group. Preferred functional groups R¹ are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R¹ are derived from C₁₂-C₁₈ fatty alcohols, for example from coconut fatty alcohol, tallow fatty alcohol, lauryl, myristyl, cetyl or stearyl alcohol or from C₁₀-C₁₈ oxo alcohols, and mixtures thereof.

OZ preferably represents an ethylene oxide group. The degrees of alkoxylation n indicated represent statistical averages that can correspond to an integer or a fractional number for a surfactant material that can actually be used. Preferred cations Y⁺ are the alkali metal ions including Na⁺ or K⁺, with Na⁺ being particularly preferred. Further cations Y⁺ can be selected from NH₄⁺, (H-A)ₐN+(B—OH)₄₋ₐ, ½Zn²⁺, ½Mg²⁺, ½Ca²⁺, ½Mn²⁺, and mixtures thereof, A being an alkylene group having 1 to 4 C atoms, B being an alkylene group having 2 to 3 C atoms and a being a number from 0 to 4.

The liquid agents may contain at least one alkyl ether sulfate of formula (T-1) as an anionic surfactant

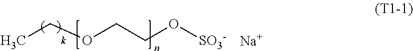

where k=11 to 19, n=2, 3, 4, 5, 6, 7 or 8. More particularly preferred representatives are Na—C₁₂₋₁₄ fatty alcohol ether sulfates having 2 EO (k=11-13, n=2 in formula T1-1).

The liquid agents may contain at least one compound of formula (T1-2) as an anionic surfactant

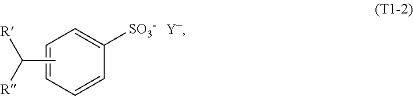

in which
R′ and R″ are, independently of one another, H or alkyl groups, and together contain 9 to 19, preferably 9 to 15, and in particular 9 to 13, C atoms, and Y⁺ is as described above for formula T1. A more particularly preferred representative can be described by the formula (T1-2a):

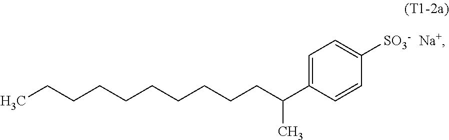

In addition to the synthetic anionic surfactant of the sulfonate and/or sulfate type, the liquid agent may also contain soaps. Saturated and unsaturated fatty acid soaps are suitable, such as the salts of lauric acid, myristic acid, palmitic acid, stearic acid, (hydrogenated) erucic acid and behenic acid, and in particular soap mixtures derived from natural fatty acids, such as coconut, palm kernel, olive oil or tallow fatty acids.

The liquid agent may contain, instead of or preferably in addition to the anionic surfactant, at least one non-ionic surfactant. Suitable non-ionic surfactants include alkoxylated fatty acid alkyl esters, alkoxylated fatty acid amides, hydroxylated alkyl glycol ethers, polyhydroxy fatty acid amides, alkylphenol polyglycol ethers, amine oxides, alkyl(poly)glucosides and mixtures thereof.

The agent may contain at least one compound of formula (T2-1) as a non-ionic surfactant

R²—O—(XO)ₘ—H (T2-1)

in which
R² represents a linear or branched C₈-C₁₈ alkyl functional group, an aryl functional group or an alkyl aryl functional group,
XO represents an ethylene oxide (EO) or propylene oxide (PO) group or mixtures thereof, and m represents a number from 1 to 50.

Particularly preferred functional groups R² in the compounds of formula (T2-1) are derived from C₁₂-C₁₈ fatty alcohols, for example from coconut fatty alcohol, tallow fatty alcohol, lauryl, myristyl, cetyl or stearyl alcohol or from C₈-C₁₈ oxo alcohols. According to formula (T2-1), XO preferably represents an ethylene oxide group. According to formula (T2-1), the degree of alkoxylation m preferably represents a number from 1 to 20, and in particular from 2 to 10, more particularly preferably numbers from 2 to 8. This degree of alkoxylation represents a statistical average that can correspond to an integer or a fractional number for a surfactant material that can actually be used.

Alkoxylated, advantageously ethoxylated, in particular primary alcohols having preferably 8 to 18 C atoms and, on average, 4 to 12 mol of ethylene oxide (EO) per mol of alcohol are preferably used as non-ionic surfactants, in which alcohols the alcohol functional group can be linear or preferably methyl-branched in position 2, or it may contain linear and methyl-branched functional groups in the mixture, as are usually present in oxo alcohol functional groups. However, alcohol ethoxylates having linear functional groups of alcohols of native origin having 12 to 18 C atoms, for example of coconut, palm, tallow fatty or oleyl alcohol, and an average of 4 to 8 EO per mol of alcohol are particularly preferred. Examples of preferred ethoxylated alcohols are C₁₂₋₁₄ alcohols having 4 EO or 7 EO, C₉₋₁₁ alcohols having 7 EO, C₁₃₋₁₅ alcohols having 5 EO, 7 EO or 8 EO, C₁₂₋₁₈ alcohols having 5 EO or 7 EO, and mixtures thereof. Preferred alcohol ethoxylates have a narrowed homolog distribution (narrow range ethoxylates, NRE). In addition to or instead of these preferred non-ionic surfactants, fatty alcohols having more than 12 EO can also be used. Examples of these are tallow fatty alcohols having 14 EO, 25 EO, 30 EO, or 40 EO. Non-ionic surfactants that contain EO and PO groups together in the molecule can also be used according to the invention. Furthermore, a mixture of a (more highly) branched ethoxylated fatty alcohol and an unbranched ethoxylated fatty alcohol is also suitable, such as a mixture of a C₁₆₋₁₈ fatty alcohol having 7 EO and 2-propylheptanol having 7 EO. In particular, the agent preferably contains a C₁₂₋₁₈ fatty alcohol having 7 EO or a C₁₃₋₁₅ oxo alcohol having 7 EO as a non-ionic surfactant.

As a non-ionic surfactant, the agent may also comprise amine oxides of formula (T2-2)

R¹R²R³NO (T2-2),

where each of R¹, R² and R³ are, independently of one another, an optionally substituted C₁-C₃₀ hydrocarbon chain. Preferred amine oxides are those in which R¹ is C₁₂-C₁₈ alkyl and R² and R³ are, independently of one another, each C₁-C₄ alkyl, in particular C₁₂-C₁₈ alkyl dimethyl amine oxides. Examples of representatives of suitable amine oxides are N-coconut alkyl-N,N-dimethyl amine oxide, N-tallow alkyl-N,N-dihydroxyethyl amine oxide, myristyl/cetyl dimethyl amine oxide or lauryl dimethyl amine oxide.

The agents according to the invention and the agents used within the scope of the use according to the invention are liquid and contain water. In this case, it is preferable for the agent to contain more than 5 wt. %, preferably more than 15 wt. %, and in particular more than 25 wt. %, of water. Particularly preferred liquid washing agents contain 5 wt. % to 90 wt. %, preferably 10 wt. % to 85 wt. %, particularly preferably 25 wt. % to 75 wt. %, and in particular 35 wt. % to 65 wt. %, of water. Alternatively, the washing agents may be low-water agents, the water content being, in preferred embodiments, less than 10 wt. %, more preferably less than 8 wt. %.

In addition, the agent may contain non-aqueous, water-miscible organic solvents. Suitable non-aqueous solvents include monovalent or polyvalent alcohols, alkanolamines or glycol ethers. The solvents are preferably selected from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3-methyl-3-methoxybutanol, propylene-glycol-t-butylether, di-n-octylether and mixtures of these solvents. The agent preferably contains non-aqueous, water-miscible organic solvents, in particular at least one alcohol, in amounts of from 0.5 wt. % to 5 wt. %; the amount of non-aqueous, water-miscible organic solvents optionally contained in the agent as an enzyme stabilizer or component of an enzyme stabilizer system is included in this figure.

The liquid agent may additionally contain further ingredients which further improve practical and/or esthetic properties, depending on the intended use. In the context of the present invention, agents, in particular if they are used as a textile treatment agent (e.g. as a washing agent or softener), may contain enzymes, builders, esterquats, silicone oils, emulsifiers, thickeners, electrolytes, pH adjusters, fluorescing agents, dyes, hydrotropes, suds suppressors, anti-redeposition agents, solvents, optical brighteners, graying inhibitors, anti-shrink agents, crease-preventing agents, dye transfer inhibitors, color-protection agents, wetting promoters, antimicrobial active ingredients, germicides, fungicides, antioxidants, corrosion inhibitors, preservatives, antistatic agents, ironing aids, waterproofing and impregnating agents, polymers, swelling and anti-slip agents and/or UV absorbers. An agent according to the invention is free of oxidatively acting bleaching agents, which include for example peroxygen compounds such as hydrogen peroxide, and chlorine compounds such as alkali hypochlorites.

The agent according to the invention or the agent used within the scope of the use according to the invention preferably contains at least one enzyme, in particular selected from protease, amylase, lipase, cellulase and/or hemicellulase such as mannanase and mixtures thereof. Enzymes of this kind are in principle of natural origin; starting from the natural molecules, variants that have often been improved for use in washing and cleaning agents are available, which are preferably used accordingly. Agents according to the invention contain an enzyme preferably in amounts of from 1×10⁻⁶ wt. % to 5 wt. %, based on the active protein. The protein concentration can be determined using known methods, for example the BCA method (bicinchoninic acid; 2,2′-bichinolyl-4,4′-dicarboxylic acid) or the Biuret method.

Among the proteases, subtilisin-type proteases are preferred. Examples of these are the subtilisins BPN′ and Carlsberg, protease PB92, subtilisins 147 and 309, the alkaline protease from Bacillus lentus, subtilisin DY, and the enzymes thermitase, proteinase K and proteases TW3 and TW7, which belong to the subtilases but no longer to the subtilisins in the narrower sense. Subtilisin Carlsberg is available in a developed form under the trade name Alcalase® from Novozymes NS, Bagsvrd, Denmark. Subtilisins 147 and 309 are marketed by Novozymes under the trade names Esperase® and Savinase®, respectively. Different variants that can be used are derived from the protease from Bacillus lentus DSM 5483. Other proteases that can be used originate from different Bacillus sp. and B. gibsonii. Other proteases that can be used are, for example, the enzymes available under the trade names Durazym®, Relase®, Everlase®, Nafizym®, Natalase®, Kannase® and Ovozymes® from Novozymes, the enzymes available under the trade names Purafect®, Purafect® OxP and Properase® from Genencor, the enzyme available under the trade name Protosol® from Advanced Biochemicals Ltd., Thane, India, the enzyme available under the trade name Wuxi® from Wuxi Snyder Bioproducts Ltd., China, the enzymes available under the trade names Proleather® and Protease P® from Amano Pharmaceuticals Ltd., Nagoya, Japan, and the enzyme available under the name Proteinase K-16 from Kao Corp., Tokyo, Japan.

Examples of amylases are α-amylases from Bacillus licheniformis, from B. amyloliquefaciens or from B. stearothermophilus, as well as the developments thereof that have been improved for use in washing and cleaning agents. The enzyme from B. licheniformis is available from Novozymes under the name Termamyl® and from Genencor under the name Purastar®ST. Development products of this α-amylase are available from Novozymes under the trade names Duramyl® and Termamyl®ultra, from Genencor under the name Purastar® OxAm, and from Daiwa Seiko Inc., Tokyo, Japan, as Keistase®. The α-amylase from B. amyloliquefaciens is marketed by Novozymes under the name BAN®, and derived variants from the α-amylase from B. stearothermophilus are marketed under the names BSG® and Novamyl®, also by Novozymes. Furthermore, the α-amylases from Bacillus sp. A 7-7 (DSM 12368) and cyclodextrin glucanotransferase (CGTase) from B. agaradherens (DSM 9948) should be mentioned. Fusion products of the mentioned molecules can also be used. Furthermore, the developments of the α-amylase from Aspergillus niger and A. oryzae, available under the trade name Fungamyl® from Novozymes, are suitable. Other commercial products are for example Amylase-LT® and Stainzyme®.

The agents may contain lipases and/or cutinases. These include, for example, the lipases that can originally be obtained from Humicola lanuginosa (Thermomyces lanuginosus) and those that have been developed, particularly those with the amino acid exchange D96L. These are marketed for example by Novozymes under the trade names Lipolase®, Lipolase®Ultra, LipoPrime®, Lipozyme® and Lipex®. Furthermore, the cutinases that have been isolated originally from Fusarium solani pisi and Humicola insolens can be used, for example. Lipases that can also be used are available from Amano under the names Lipase CE®, Lipase P®, Lipase B®, and Lipase CES®, Lipase AKG®, Bacillus sp. Lipase®, Lipase AP®, Lipase M-AP® and Lipase AML®. From Genencor, the lipases or cutinases of which the starting enzymes have been isolated originally from Pseudomonas mendocina and Fusarium solanii can be used, for example. The preparations M1 Lipase® and Lipomax® originally marketed by Gist-Brocades, the enzymes marketed by Meito Sangyo KK, Japan, under the names Lipase MY-30, Lipase OF® and Lipase PL®, and the product Lumafast® from Genencor should be mentioned as other important commercial products.

Depending on their purpose, the agents may contain cellulases as pure enzymes, as enzyme preparations or in the form of mixtures in which the individual components are advantageously complementary in terms of their different performance aspects. These performance aspects include in particular anything from contributions to the primary washing performance, the secondary washing performance of the agent (anti-redeposition or graying inhibitors) and softening (effect on fabric), to producing a “stonewashed” effect. A usable fungal cellulase preparation that is rich in endoglucanase (EG) and the developments thereof are provided by Novozymes under the trade name Celluzyme®. The products Endolase® and Carezyme® also available from Novozymes are based on 50 kD-EG and 43 kD-EG, respectively, from H. insolens DSM 1800. Other commercial products from this company are Cellusoft® and Renozyme®. It is also possible to use the cellulase 20 kD-EG from Melanocarpus, which is available from AB Enzymes, Finland, under the trade names Ecostone® and Biotouch®. Other commercial products from AB Enzymes are Econase® and Ecopulp®. The cellulase originating from Bacillus sp. CBS 670.93 is available from Genencor under the trade name Puradax®. Other commercial products from Genencor are “Genencor detergent cellulase L” and IndiAge®Neutra.

The agents may contain further enzymes which can be grouped together under the term “hemicellulases”. These include, for example, mannanases, xanthan lyases, pectin lyases (=pectinases), pectinesterases, pectate lyases, xyloglucanases (=xylases), pullulanases, and β-glucanases. Suitable mannanases are, for example, available from Novozymes under the names Gamanase®, Pektinex AR® and Mannaway®, from AB Enzymes under the name Rohapec® B 1L, and from Diversa Corp. under the name Pyrolase®. The β-glucanase obtained from B. subtilis is available from Novozymes under the name Cereflo®.

The enzymes are produced by means of suitable microorganisms according to biotechnological methods that are known per se, for example by transgenic expression hosts of the Bacillus species, for example, or filamentous fungi.

An enzyme can be protected, in particular during storage, against damage, for example inactivation, denaturing, or decomposition caused, for example, by physical influences, oxidation, or proteolytic cleavage. To this end, the agents may contain enzyme stabilizers. One group of enzyme stabilizers are reversible protease inhibitors. Benzamidine hydrochloride, borax, boric acids, boronic acids or the salts or esters thereof are often used, in particular derivatives having aromatic groups, for example ortho-substituted, meta-substituted or para-substituted phenyl boronic acids or the salts or esters thereof, and/or peptide aldehydes, i.e. oligopeptides having a reduced C-terminus, ovomucoid, and/or leupeptin. Other enzyme stabilizers are alkanolamines, such as mono, di and tri ethanol and propanolamine and mixtures thereof, aliphatic carboxylic acids up to C₁₂, such as succinic acid, other dicarboxylic acids or salts of the mentioned acids, end-capped fatty acid amide alkoxylates, low aliphatic alcohols, such as ethanol or propanol, but in particular polyols, for example glycerol, ethylene glycol, propylene glycol or sorbitol, but also di-glycerol phosphate, calcium salts, for example calcium acetate or calcium formate, and magnesium salts. Preferably, combinations of stabilizers are used, for example of polyols, boric acid and/or borax, or of boric acid or borate, reducing salts and succinic acid or other dicarboxylic acids, or of boric acid or borate with polyols or polyamino compounds and with reducing salts.

An agent that is suitable as a textile treatment agent or cleaning agent preferably contains at least one water-soluble or water-insoluble, organic or inorganic builder. The water-soluble organic builders include polycarboxylic acids, in particular citric acid, adipic acid, succinic acid, glutaric acid, malic acid, tartaric acid, maleic acid, fumaric acid and saccharic acids, monomeric and polymeric aminopolycarboxylic acids, in particular methylglycinediacetic acid, nitrilotriacetic acid, and ethylenediaminetetraacetic acid, as well as polyaspartic acid, polyphosphonic acids, in particular amino tris(methylenephosphonic acid), ethylenediaminetetrakis(methylenephosphonic acid), and 1-hydroxyethane-1,1-diphosphonic acid, polymeric hydroxy compounds such as dextrin, and polymeric (poly)carboxylic acids, polymeric acrylic acids, methacrylic acids, maleic acids, and mixed polymers thereof, which may also contain in the polymer small proportions of polymerizable substances, without a carboxylic acid functionality. Compounds of this class which are suitable, although less preferred, are copolymers of acrylic acid or methacrylic acid with vinyl ethers, such as vinyl methyl ethers, vinyl esters, ethylene, propylene, and styrene, in which the proportion of the acid is at least 50 wt. %. The organic builders, for preparation of the liquid agents, may be used in the form of aqueous solutions, for example in the form of 30 to 50 wt. % aqueous solutions. All stated acids are generally used in the form of their water-soluble salts, in particular their alkali salts. The salts of polycarboxylic acids such as citric acid, adipic acid, succinic acid, glutaric acid, tartaric acid, saccharic acids and mixtures thereof are preferred. Builders, if desired, may be contained in the agents in amounts of up to 40 wt. %, in particular up to 25 wt. %, and preferably from 1 wt. % to 8 wt. %. Laundry post-treatment agents, such as softeners, may optionally also be free of builders.

Optical brighteners are preferably selected from the substance classes of distyrylbiphenyls, stilbenes, 4,4′-diamino-2,2′-stilbene disulfonic acids, cumarines, dihydroquinolones, 1,3-diarylpyrazolines, naphthalic acid imides, benzoxazole systems, benzisoxazole systems, benzimidazole systems, pyrene derivatives substituted with heterocycles, and mixtures thereof. Particularly preferred optical brighteners include disodium-4,4′-bis-(2-morpholino-4-anilino-s-triazin-6-ylamino)stilbene disulfonate (for example available as Tinopal® DMS from BASF SE), disodium-2,2′-bis-(phenyl-styryl)disulfonate (for example available as Tinopal® CBS from BASF SE), 4,4′-bis[(4-anilino-6-[bis(2-hydroxyethyl)amino]-1,3,5-triazin-2-yl)amino]stilbene-2,2′-disulfonic acid (for example available as Tinopal® UNPA from BASF SE), hexasodium-2,2′-vinylenebis[(3-sulphonato-4,1-phenylene)imino[6-(diethyl amino)-1,3,5-triazin-4,2-diyl]imino]]bis-(benzene-1,4-disulfonate) (for example available as Tinopal® SFP from BASF SE), 2,2′-(2,5-thiophendiyl)bis[5-1,1-dimethylethyl)-benzoxazole (for example available as Tinopal® SFP from BASF SE) and/or 2,5-bis(benzoxazol-2-yl)thiophene.

Furthermore, the agents that are suitable as textile treatment agents or cleaning agents may also contain components that positively influence the capability for washing out oil and grease from textiles, which components are referred to as “soil release active ingredients”. This effect is particularly apparent when a textile is soiled which has been previously washed several times with an agent that contains this oil and grease-dissolving component. Preferred oil and grease-dissolving components include, for example, non-ionic cellulose ethers such as methylcellulose and methylhydroxypropylcellulose having a proportion of 15 to 30 wt. % of methoxy groups and 1 to 15 wt. % of hydroxypropoxyl groups, based in each case on the non-ionic cellulose ether, and the polymers of phthalic acid and/or terephthalic acid, known from the prior art, or the derivatives thereof with monomeric and/or polymeric diols, in particular polymers of ethylene terephthalates and/or polyethylene glycol terephthalates or anionically and/or non-ionically modified derivatives thereof.

The textile treatment agents or cleaning agents may also contain dye transfer inhibitors, preferably in amounts of from 0.1 wt. % to 2 wt. %, in particular from 0.1 wt. % to 1 wt. %, which in one preferred embodiment of the invention are polymers of vinylpyrrolidone, vinyl imidazole, vinyl pyridine-N-oxide, or copolymers thereof. It is preferable for the dye transfer inhibitor to be a polymer or a copolymer of cyclic amines such as vinylpyrrolidone and/or vinylimidazole. Polymers suitable as dye transfer inhibitors include polyvinylpyrrolidone (PVP), polyvinylimidazole (PVI), copolymers of vinylpyrrolidone and vinylimidazole (PVP/PVI), polyvinylpyridine-N-oxide, poly-N-carboxymethyl-4-vinylpyridium chloride, polyethylene glycol-modified copolymers of vinylpyrrolidone and vinylimidazole, and mixtures thereof. Polyvinylpyrrolidone (PVP), polyvinylimidazole (PVI) or copolymers of vinylpyrrolidone and vinylimidazole (PVP/PVI) are particularly preferably used as dye transfer inhibitors. The polyvinylpyrrolidones (PVP) used preferably have an average molecular weight of from 2,500 g/mol to 400,000 g/mol and are commercially available from ISP Chemicals as PVP K 15, PVP K 30, PVP K 60 or PVP K 90, or from BASF SE as Sokalan® HP 50 or Sokalan® HP 53. The copolymers of vinylpyrrolidone and vinylimidazole (PVP/PVI) used preferably have a molecular weight in the range of from 5,000 g/mol to 100,000 g/mol. A PVP/PVI copolymer is commercially available from BASF SE under the name Sokalan® HP 56. Other dye transfer inhibitors that can be extremely preferably used are polyethylene glycol-modified copolymers of vinylpyrrolidone and vinylimidazole, which are available, for example, from BASF SE under the name Sokalan® HP 66.

The function of graying inhibitors is to keep the dirt that is removed from the textile fiber suspended in the liquor. Water-soluble colloids, which are usually organic, are suitable for this purpose, for example starch, sizing material, gelatin, salts of ethercarboxylic acids or ethersulfonic acids of starch or of cellulose, or salts of acidic sulfuric acid esters of cellulose or of starch. Water-soluble polyamides containing acidic groups are also suitable for this purpose. Starch derivatives other than those mentioned above may also be used, for example aldehyde starches. Cellulose ethers such as carboxymethylcellulose (Na salt), methylcellulose, hydroxyalkylcellulose, and mixed ethers such as methylhydroxyethylcellulose, methylhydroxypropylcellulose, methylcarboxymethylcellulose, and mixtures thereof may preferably be used, for example in amounts of from 0.1 to 5 wt. %, based on the agents.

The invention further relates to a method for textile treatment, comprising the method steps of:

(a) providing a solution comprising a washing agent according to the invention, and

(b) bringing a stained textile into contact with the solution according to (a).

The solution can be prepared by dissolving an agent according to the invention or the individual components thereof, it being possible to combine some of the components to form an agent that might no longer be in accordance with the invention. Within the context of the embodiment mentioned last, it is possible to use an agent that is free of acyl hydrazone and add an acyl hydrazone that is essential to the invention to the solution. It is likewise possible to use an agent that is free of reducing agents and add a reducing agent to the solution, and to use an agent that is free of reducing agents and acyl hydrazone and add the combination that is essential to the invention to the solution or individually add the components of said combination to said solution. For preparing said solution, it is preferable according to the invention for 10 g to 110 g, in particular 15 to 100 g, of the agent to be mixed with 5 l to 25 l of water, in particular 10 l to 20 l of water.

In the washing method, which can be carried out by hand or using conventional washing machines, temperatures of 60° C. or less, in particular 50° C. or less, and particularly preferably from 15° C. to 45° C., are preferably used. These specified temperatures relate to the temperatures used in the washing steps.

### EXAMPLES

Textile fabrics made of cotton and stained with a total of 90 different standardized stains were washed under the same conditions for 75 minutes at 40° C. with washing liquors (consisting of water having a degree of hardness of 16° dH) comprising 4.1 g/l of a liquid washing agent (V0) that contained a surfactant but no bleaching agent, with a washing liquor (V1) to which 0.7 g/l morpholinium-4-(2-(2((2-hydroxyphenylmethyl)-methylene)-hydrazinyl)-2-oxoethyl)-4-methyl-chloride was also added, but which was otherwise the same as V0, with a washing liquor (V2) to which 0.7 g/l hydroxylamine hydrochloride was also added, but which was otherwise the same as V0, or with a washing liquor (M1) to which 0.7 g/l morpholinium-4-(2-(2((2-hydroxyphenylmethyl)-methylene)-hydrazinyl)-2-oxoethyl)-4-methyl-chloride and 0.7 g/l hydroxylamine hydrochloride was also added, but which was otherwise the same as V0. The treated substance substrates were then dried and subject to a color measurement in order to determine the Y value (brightness). The stain-removal performance was higher if V1 was used than if V0 was used for 9 stains. The stain-removal performance was higher if V2 was used than if V0 was used for 6 stains. The stain-removal performance was higher if M1 was used than if V0 was used for 19 stains. For none of the stains was the stain-removal performance lower if V1, V2 or M1 was used than if V0 was used.

What is claimed is:

1. A method for treating textiles comprising the step wherein textiles are contacted with an agent comprising a combination of an acyl hydrazone of general formula I, 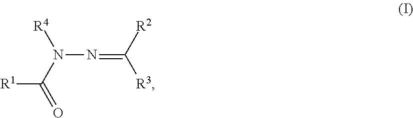
in which R¹ represents a CF₃ or a C₁₋₂₈ alkyl, C₂₋₂₈ alkenyl, C₂₋₂₂ alkinyl, C₃₋₁₂ cycloalkyl, C₃₋₁₂ cycloalkenyl, phenyl, naphthyl, C₇₋₉ aralkyl, C₃₋₂₀ heteroalkyl or C₃₋₁₂ cycloheteroalkyl group,
R² and R³ represent, independently of one another, hydrogen or an optionally substituted C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl or heteroaryl group, or R² and R³ represent, together with the carbon atom which connects them, a optionally substituted 5, 6, 7, 8 or 9-membered ring, which may optionally contain heteroatoms, and
R⁴ represents hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group or an optionally substituted phenyl or naphthyl or heteroaryl group,
and further comprising reducing agents.

2. A method for treating textiles comprising the step wherein textiles are contacted 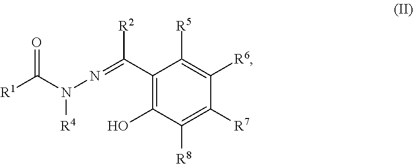
with an agent comprising a combination an acyl hydrazone of general formula (II),
in which R¹ represents a C₁₋₄ alkyl group that has a substituent selected from 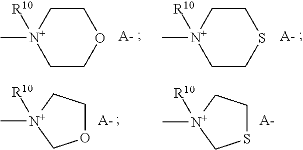
in which R¹⁰ represents hydrogen or an optionally substituted C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group, and A⁻ represents the anion of an organic or inorganic acid,
R² and R⁴ have the meaning specified for formula (I), and
R⁵, R⁶, R⁷ and R⁸ represent, independently of one another, R¹, hydrogen, halogen, a hydroxy, amino, substituted N-mono- or di-C₁₋₄ alkyl or C₂₋₄ hydroxyalkyl amino, N-phenyl or N-naphthyl amino, C₁₋₂₈ alkyl, C₁₋₂₈ alkoxy, phenoxy, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, phenyl or naphthyl group, wherein the substituents are selected from C₁₋₄ alkyl, C₁₋₄ alkoxy, hydroxy, sulfo, sulfato, halogen, cyano, nitro, carboxy, phenyl, phenoxy, naphthoxy, amino, N-mono- or di-C₁₋₄ alkyl or C₂₋₄ hydroxyalkyl amino, N-phenyl or N-naphthyl amino groups, or
R⁵ and R⁶ or R⁶ and R⁷ or R⁷ and R⁸ are interconnected so as to form 1, 2 or 3 carbocyclic or O, NR¹⁰ or S heterocyclic, optionally aromatic and/or optionally C₁₋₆ alkyl-substituted rings,
and further comprising reducing agents.

3. The method according to claim 1, wherein, in the combination, the weight ratio of acyl hydrazone to reducing agent is in the range of from 5:1 to 1:5,000.

4. A liquid washing or cleaning agent, containing 1 wt. % to 70 wt. % of at least one surfactant, at least one reducing agent, and at least one acyl hydrazone of general formula I, 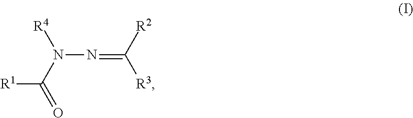
in which R¹ represents a CF₃ or a C₁₋₂₈ alkyl, C₂₋₂₈ alkenyl, C₂₋₂₂ alkinyl, C₃₋₁₂ cycloalkyl, C₃₋₁₂ cycloalkenyl, phenyl, naphthyl, C₇₋₉ aralkyl, C₃₋₂₀ heteroalkyl or C₃₋₁₂ cycloheteroalkyl group,
R² and R³ represent, independently of one another, hydrogen or an optionally substituted C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl or heteroaryl group, or R² and R³ represent, together with the carbon atom which connects them, an optionally substituted 5, 6, 7, 8 or 9-membered ring, which may optionally contain heteroatoms, and
R⁴ represents hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group or an optionally substituted phenyl or naphthyl or heteroaryl group, and
water.

5. A liquid washing or cleaning agent, containing 1 wt. % to 70 wt. % of at least one surfactant, at least one reducing agent, and at least one acyl hydrazone of general formula (II), 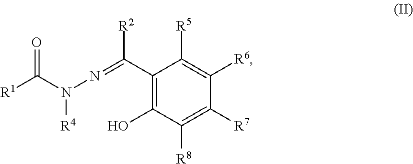
in which R¹ represents a C₁₋₄ alkyl group that has a substituent selected from 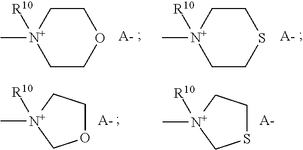
in which R¹⁰ represents hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group, and A⁻ represents the anion of an organic or inorganic acid,
R² and R⁴ have the meaning specified for formula (I), and
R⁵, R⁶, R⁷ and R⁸ represent, independently of one another, R¹, hydrogen, halogen, a hydroxy, amino, optionally substituted N-mono- or di-C₁₋₄ alkyl or C₂₋₄ hydroxyalkyl amino, N-phenyl or N-naphthyl amino, C₁₋₂₈ alkyl, C₁₋₂₈ alkoxy, phenoxy, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, phenyl or naphthyl group, wherein the substituents are selected from C₁₋₄ alkyl, C₁₋₄ alkoxy, hydroxy, sulfo, sulfato, halogen, cyano, nitro, carboxy, phenyl, phenoxy, naphthoxy, amino, N-mono- or di-C₁₋₄ alkyl or C₂₋₄ hydroxyalkyl amino, N-phenyl or N-naphthyl amino groups, or
R⁵ and R⁶ or R⁶ and R⁷ or R⁷ and R⁸ are interconnected so as to form 1, 2 or 3 carbocyclic or O, NR¹⁰ or S heterocyclic, optionally aromatic and/or optionally C₁₋₆ alkyl-substituted rings.

7. The agent according to claim 4, characterized in that it contains 0.001 wt. % to 5 wt. % of acyl hydrazone.

8. The agent according to claim 4, characterized in that it contains 0.1 wt. % to 5 wt. % of reducing agents.

9. The method according to claim 1, wherein the reducing agent and/or acyl hydrazone are present in a dissolved or suspended form and, both or at least one of them are present in the form of powder or granules containing conventional inert carrier materials.

10. The method according to claim 2, wherein, in the combination, the weight ratio of acyl hydrazone to reducing agent is in the range of from 4:1 to 1:40.

11. The agent according to claim 6, characterized in that it contains 0.05 wt. % to 2 wt. % of acyl hydrazone.

12. The agent according to claim 7, characterized in that it contains 0.5 wt. % to 2 wt. % of reducing agents.

13. The agent according to claim 4, characterized in that the reducing agent and/or acyl hydrazone are present in a dissolved or suspended form and, both or at least one of them are present in the form of powder or, granules containing conventional inert carrier materials.
